(19) United States
(12) Patent Application Publication
(10) Pub. No.: US 2012/0176056 A1
(43) Pub. Date: Jul. 12, 2012

(54) Circuit Arrangement for Operation of at Least One LED

(75) Inventor: Bernd Rudolph, Forstern (DE)

(73) Assignee: OSRAM AG, Muenchen (DE)

(21) Appl. No.: 13/497,056

(22) PCT Filed: Aug. 11, 2010
(86) PCT No.: PCT/EP2010/061667

§ 371 Date: Mar. 20, 2012

(30) Foreign Application Priority Data
Sep. 22, 2009 (DE) 10 2009 042 433.4

(51) Int. Cl. H05B 37/00

(52) U.S. Cl. 315/200 R; 315/224

(57) ABSTRACT

In various embodiments, a circuit for operating an LED includes input terminals for coupling to a supply voltage; output terminals for providing output DC voltage(s) to the LED(s); an inverter having a bridge circuit with at least first and second electronic switches comprising control electrodes, reference electrodes and working electrodes, wherein first and second electronic switches are serially coupled between input terminals, forming a first bridge center point; a first inductor serially coupled between first bridge center point and an output terminal; and a drive circuit having output terminals, wherein one output terminal is coupled to control electrode of first electronic switch and second output terminal is coupled to control electrode of second electronic switch; configured so that-drive circuit comprises control devices, wherein one control device includes a second inductor magnetically coupled to the first inductor, and wherein second control device includes third inductor magnetically coupled to first inductor.

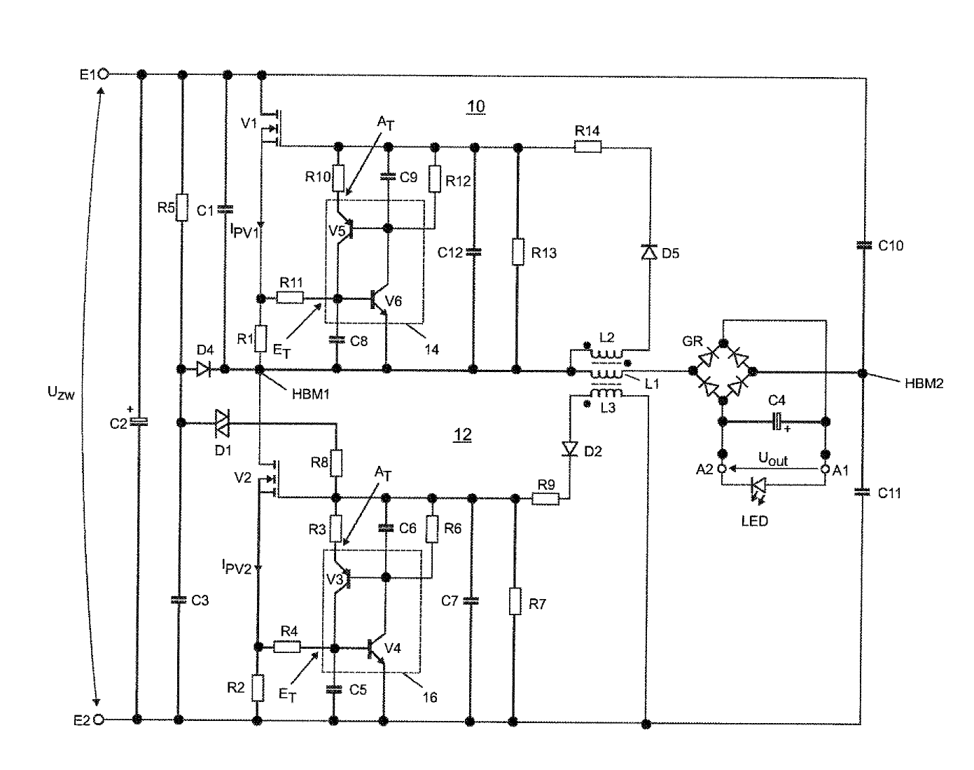

### TECHNICAL FIELD

The present invention relates to a circuit arrangement for operating at least one LED, said circuit arrangement having an input with a first and a second input terminal for coupling to a supply voltage, an output with a first and a second output terminal for providing an output DC voltage to the at least one LED, an inverter having a bridge circuit with at least one first and one second electronic switch, wherein the first and the second electronic switch each include a control electrode, a reference electrode and a working electrode, wherein the first and the second electronic switch are serially coupled between the first and the second input terminal, forming a first bridge center point, a first inductor which is serially coupled between the first bridge center point and one of the output terminals, and a drive circuit having at least one first and one second output terminal, wherein the first output terminal is coupled to the control electrode of the first electronic switch and the second output terminal is coupled to the control electrode of the second electronic switch.

### BACKGROUND ART

A circuit arrangement of this type is known from WO 2007/065815 A1. In said known circuit arrangement the switches of the inverter are controlled by way of a relatively complicated drive device including two integrated circuits. In addition to a half-bridge driver with integrated oscillator the circuit contains a regulating amplifier (AMP) for compensating for tolerances of the components and line voltage changes that have an impact on the LED current. The circuit is comparatively complex and expensive as a result. A DC voltage supply for the drive device is required in addition.

### SUMMARY OF THE INVENTION

The object underlying the present invention is therefore to develop a generic circuit arrangement in such a way that it manages without an integrated circuit and with a minimum number of standard components.

This object is achieved by means of a circuit arrangement having the features of claim 1.

The present invention is based on the knowledge that said object can be achieved in a particularly simple manner if the circuit arrangement is conceived as a free oscillator. To that extent the drive circuit includes a first and a second control device, wherein the first control device includes a second inductor which is magnetically coupled to the first inductor, and wherein the second control device includes a third inductor which is magnetically coupled to the first inductor. By means of said measures the need for an integrated circuit is removed. As a result thereof the requirements that applied in the prior art in order to derive a supply voltage for the integrated circuit from the rectified line voltage can be dispense with. The circuit is furthermore characterized by a high level of efficiency as well as by a symmetric magnetic modulation of the first inductor.

A preferred embodiment variant is characterized in that between the second inductor and the first electronic switch there is coupled a first turn-off device which is configured to switch the first electronic switch to blocking if the current through the first electronic switch has reached a predefinable maximum value.

Alternatively or in addition, a second turn-off device can be coupled between the third inductor and the second electronic switch, said second turn-off device being configured to switch the second electronic switch to blocking if the current through the second electronic switch has reached a predefinable maximum value. Since the arithmetic mean for a given current waveform is defined by the peak value, a very good current regulation of the LED is achieved by this means.

In this connection it is preferably provided that the first and the second turn-off device each include a current measuring device for measuring the current through the respective electronic switch, as well as a thyristor simulation in each case having a turn-on and a turn-off input, wherein the turn-on input is coupled to the respective current measuring device and the turn-off input is coupled to the respective inductor. The use of thyristor simulations enables very fast clearing of the control electrode of the respective switch of the inverter. This allows the current provided to the LED to be regulated very precisely. If a shunt is used as a current measuring device for measuring the current through the respective switch of the inverter, the voltage dropping across the shunt can be used directly to trigger the respective thyristor simulation and consequently to turn off the respective electronic switch. The term turn-on refers in this context to the turning-on of the thyristor simulation, which subsequently results in the turning-off of the respective electronic switch.

In this connection a first filter device is preferably coupled between the respective current measuring device and the respective turn-on input in each case. In addition a timing relay is preferably coupled between the respective inductor and the respective thyristor simulation in each case. It is furthermore preferred that a second filter device be coupled between the respective timing relay and the respective turn-off input in each case. The first and the second filter device serve to prevent capacitive couplings which could cause inadvertent triggering of the thyristor simulation. Considering that the change dU/dt in the voltage at the first bridge center point is typically 300 V/μs, the relevance of capacitive couplings becomes clear. By using timing relays between the respective inductor and the respective turn-off input of the respective thyristor simulation it is possible in a particularly simple manner to set a dead time in which the switches of the inverter are off, i.e. blocking. Since with the described approach the electrical switches of the inverter are not switched off until after a predefinable maximum value has been reached, radio frequency interference suppression of the circuit is possible using very simple means. Using a pulsating DC voltage as supply voltage results in a frequency-modulated mode of operation of the inverter, since different periods of time until the respective maximum current value is reached are required, depending on the amplitude of the supply voltage at a given instant.

A respective diode is preferably coupled between the respective inductor and the respective thyristor simulation. This ensures that only the control voltage desired at a given time is routed to the respective switch of the inverter.

The respective thyristor simulation preferably includes a PNP transistor and an NPN transistor in each case, wherein the working electrode of the PNP transistor is coupled to the turn-off input and the control electrode of the NPN transistor is coupled to the turn-on input of the respective thyristor simulation. In this way it is possible, with very little outlay of materials, to simulate a thyristor which offers the advantage over a true thyristor that the static and dynamic characteristics can be precisely adjusted according to requirements by means of its external circuit configuration. Preferably the first and the second electronic switch are embodied as MOSFETs. This allows them to be turned on and off using small voltages and practically without current.

In a preferred embodiment variant a trapezoidal capacitor is coupled in parallel with at least one of the two electronic switches. This enables a so-called “hard” switching to be prevented. In other words it provides a simple means by which the switches of the inverter can be switched free of switching load. This leads to a further reduction in radio frequency interference.

A circuit arrangement according to the invention preferably also includes a start circuit which is coupled between the first input terminal and the control electrode of the second electronic switch. Since the second electronic switch is coupled by means of its reference electrode to ground potential, the free oscillator can be started up very easily in this way.

In a preferred embodiment variant a storage capacitor is provided which is coupled between the first and the second input terminal, the storage capacitor, in conjunction with the load circuit connected in parallel therewith, being configured in such a way that the supply voltage includes an alternating component of up to 50% referred to its peak value. As mentioned, a pulsation of the supply voltage of said kind causes a state of frequency modulation to become established, which is to say that the period of time until the maximum current is reached by the respective switch of the bridge circuit varies as a function of the supply voltage. This results in the radio frequency interference being dispersed over a greater frequency band, thereby considerably facilitating compliance with the respective EMC standards.

A rectifier is preferably coupled between the first inductor and the output of the circuit arrangement. This then ensures that the LED is provided with a direct current. The LED can, however, also be coupled via a separate transformer whose primary winding is coupled in series with the first inductor and to the secondary winding of which the rectifier is connected, without altering the principle of operation of the circuit. Potential freedom for the LED can be established in this way.

Alternatively it can be provided that the circuit arrangement additionally includes a fourth inductor and a rectifier, wherein the fourth inductor is magnetically coupled to the first, the second and the third inductor, wherein the rectifier is coupled between the fourth inductor and the output of the circuit arrangement. The potential freedom of the LED is also ensured by this means, the fourth inductor being spatially coupled to at least one of the other inductors in a particularly space-saving arrangement. This can be achieved in that the fourth inductor represents an auxiliary winding, that is to say that second, third and fourth inductor represent auxiliary windings and all four inductors are wound on the same core.

Further advantageous embodiment variants will emerge from the dependent claims.

### BRIEF DESCRIPTION OF THE DRAWING(S)

An exemplary embodiment will now be described hereinbelow with reference to the attached drawing, in which an exemplary embodiment of a circuit arrangement according to the invention is shown in a schematic representation.

### PREFERRED EMBODIMENT OF THE INVENTION

The single FIGURE shows an exemplary embodiment of a circuit arrangement according to the invention in a schematic representation. A supply voltage U_{Zw}, which can represent in particular what is termed the direct-current link voltage, is connected to an input with a first and a second input terminal. A capacitor C2 is provided for the purpose of stabilizing said voltage. The alternating component of the voltage U_{Zw} present at the input can be influenced by the dimensioning of the capacitor C2. The ratio of alternating component to direct component of the voltage U_{Zw} affects the radio frequency interference caused by the circuit arrangement.

The circuit includes an inverter having two transistors V1, V2 in a half-bridge arrangement. Connected to the transistor V1, V2 is a source resistor R1, R2, respectively, which serves for measuring the current through the respective transistor V1, V2. A first half-bridge center point HBM1 of the circuit arrangement is formed between V1, R1 on the one side and V2, R2 on the other side.

The circuit arrangement additionally includes an output with a first output terminal A1 and a second output terminal A2 for providing an output DC voltage Uₒᵤₜ to at least one LED. In the present case a choke L1 is initially provided between the first half-bridge center point HBM1 and the output A1, A2 of the circuit arrangement, a rectifier GR being serially coupled to the choke L1. The choke L1 is coupled to a first input of a rectifier. The second input of the rectifier is coupled to the input terminal E1 on one side via a capacitor C10 and to the input terminal E2 on the other side via a capacitor C11. A second half-bridge center point HBM2 is formed between the capacitors C10 and C11. The voltage dropping at the output of the rectifier is the voltage Uₒᵤₜ, which is stabilized by means of a capacitor C4.

The circuit arrangement additionally includes a second inductor L2 and a third inductor L3, which are magnetically coupled to the choke L1. Coupled between the second inductor L2 and the switch V1 is a first turn-off device 10 which is configured to switch the switch V1 to blocking when the current I_{Pv1} through the switch V1 has reached a predefinable maximum value Iₘₐₓ₁. In an analogous manner there is coupled between the third inductor L3 and the switch V2 a second turn-off device 12 which is configured to switch the switch V2 to blocking when the current I_{Pv2} through the second electronic switch V2 has reached a value Iₘₐₓ₂.

The first 10 and the second turn-off device 12 use the respective source resistor R1, R2 for measuring the current I_{Pv1}, I_{Pv2} through the respective switch V1, V2. Each turn-off device 10, 12 additionally includes a thyristor simulation 14, 16, each including a turn-on input E_{T} and a turn-off input A_{T}. The respective turn-on input E_{T} is coupled to the respective current measuring device R1, R2, while the respective turn-off input A_{T} is coupled to the respective inductor L2, L3. The respective thyristor simulation 14, 16 includes two transistors, the thyristor simulation 14 having the transistors V5, V6, and the thyristor simulation 16 having the transistors V3, V4.

Coupled between the current measuring device R1 and the input E_{T} of the thyristor simulation 14 is a filter device including the ohmic resistor R11 and the capacitor C8. Said filter device prevents any capacitive couplings from causing an inadvertent triggering of the thyristor simulation 14. The ohmic resistor R4 and the capacitor C5 perform a similar function in relation to the thyristor simulation 16.

A corresponding filter device is provided for the gate terminal of the respective other transistor V5, V3 of the respective thyristor simulation 14, 16. Referring to the thyristor simulation 14, these are the ohmic resistor R12 and the capacitor C9, while the capacitor C6 and the ohmic resistor R6 fulfill this function for the thyristor simulation 16. Each turn-off device additionally includes a timing relay by means of which the dead time can be set in which the two switches V1, V2 of the half-bridge arrangement are turned off, i.e. switched to blocking. The ohmic resistors R14, R13 and the capacitor C12 handle these tasks for the turn-off device 10. In the case of the turn-off device 12 this function is provided by the ohmic resistors R9, R7 and the capacitor C7. An ohmic resistor R10 is coupled between the control electrode of the switch V1 and the emitter of the transistor V5. In analogous fashion, a resistor R3 is coupled between the control electrode of the switch V2 and the emitter of the transistor V3.

A respective diode D5, D2 coupled between the respective inductor L2, L3 and the respective thyristor simulation 14, 16 ensures that only the desired voltage polarity of the respective inductor L2, L3 in each case is used for driving the respective switch V1, V2.

A trapezoidal capacitor C1 is coupled in parallel with the arrangement of the switch V1 and the ohmic resistor R1. Additionally provided is an RC Diac start circuit including the ohmic resistor R5, the capacitor C3, the diode D4, the Diac D1 and the ohmic resistor R8.

With regard to the mode of operation: The free oscillator is excited into oscillation by means of the said start circuit and then oscillates freely with the aid of the feedback via the auxiliary windings L2, L3 on the current-limiting choke L1. The auxiliary windings L2, L3 generate sufficient secondary voltage in order to turn on the switches V1, V2 embodied as MOSFETs in a reliable manner. In order to realize a dead time in the active driving of the switches V1, V2, the latter are turned on with a defined delay by means of the said timing relays as well as the gates of the MOSFETs V1, V2 that are to be charged in each case.

In a first phase the switch V1 is closed. The current I_{Pv1} increases and flows in the circuit V1, R1, L1 and via the capacitor C10 on the one hand, and via the capacitors C11 and C2 on the other hand, back to the switch V1. Once the voltage drop at the resistor R1 reaches a predefinable value which is specified by the base-emitter flow voltage U_{BEF} of the transistor V6 of the thyristor simulation 14, the thyristor simulation 14 is triggered, which is to say it becomes conducting, as a result of which the gate of the switch V1 is cleared. This causes the switch V1 to transition to the blocking state. The corresponding switching operation is subsequently completed by the switch V2 by corresponding coupling of the inductor L3 upon expiration of a dead time. This process is repeated, with the result that the circuit arrangement oscillates freely.

Since peak value and arithmetic mean are correlated in a given current waveform, which is to say that the current provided to the LED is defined by the peak value, the circuit effects good current regulation. Because the temperature coefficient of the base-emitter flow voltage is negative, the circuit arrangement is also thermally stable. A reduction in the thermal penetration can be achieved through temperature compensation of the source resistors R1, R2 by means of, for example, an NTC resistor or a Schottky diode.

As already mentioned, the operating frequency of the circuit arrangement is variable and depends on the input voltage, the inductor L1 and the peak current requiring to be switched off:

$${I}_{max 1} = \frac{{U}_{BEF} ( V 6 )}{R 1} or {I}_{max 2} = \frac{{U}_{BEF} ( V4 )}{R 2} .$$

If, during symmetric operation, Iₘₐₓ₁ is equal to Iₘₐₓ₂, the resulting frequency is approximately

$$f = 4 \cdot \frac{{L}_{1} \cdot {I}_{max 1}}{{U}_{Zw}} .$$

Accordingly, the circuit arrangement possesses very good credentials for providing simple radio frequency interference suppression, since as a result of the trapezoidal capacitor C1 the switches are not subject to hard switching and a frequency modulation takes place during pulsating DC voltage by way of the frequency dependence of the input voltage U_{Zw}.

In the exemplary embodiment shown in the FIGURE the LED is coupled in terms of potential to the rest of the circuit arrangement. Potential freedom for the at least one LED can be established without difficulty by way of an additional winding on the inductor L1 or a separate transformer.

On a practical example implementation, a change in the line voltage of plus/minus 10% resulted in changes in the LED current of only between plus 2.6% and minus 3.7%.

1. A circuit arrangement for operating at least one LED, said circuit arrangement comprising:
an input with a first and a second input terminal for coupling to a supply voltage;
an output with a first and a second output terminal for providing an output DC voltage to the at least one LED;
an inverter having a bridge circuit with at least one first and one second electronic switch, wherein the first and the second electronic switch each comprise a control electrode, a reference electrode and a working electrode, wherein the first and the second electronic switch are serially coupled between the first and the second input terminal, forming a first bridge center point;
a first inductor which is serially coupled between the first bridge center point and one of the output terminals; and
a drive circuit having at least one first and one second output terminal, wherein the first output terminal is coupled to the control electrode of the first electronic switch and the second output terminal is coupled to the control electrode of the second electronic switch;
configured so that
the drive circuit comprises a first and a second control device, wherein the first control device includes a second inductor which is magnetically coupled to the first inductor, and wherein the second control device includes a third inductor which is magnetically coupled to the first inductor.

2. The circuit arrangement as claimed in claim 1,
wherein
coupled between the second inductor and the first electronic switch is a first turn-off device which is configured to switch the first electronic switch to blocking when the current through the first electronic switch has reached a predefinable maximum value.

3. The circuit arrangement as claimed in claim 1,
wherein,
coupled between the third inductor and the second electronic switch is a second turn-off device which is configured to switch the second electronic switch to blocking when the current through the second electronic switch has reached a predefinable maximum value.

4. The circuit arrangement as claimed in claim 1,
wherein
the at least one turn-off device includes a respective current measuring device for measuring the current through the respective electronic switch, as well as a respective thyristor simulation having a turn-on and a turn-off input, wherein the turn-on input is coupled to the respective current measuring device and the turn-off input is coupled to the respective inductor.

5. The circuit arrangement as claimed in claim 4,
wherein
a first filter device is coupled between the respective current measuring device and the respective turn-on input in each case.

6. The circuit arrangement as claimed in claim 5,
wherein
a timing relay is coupled between the respective inductor and the respective thyristor simulation in each case.

7. The circuit arrangement as claimed in claim 6,
wherein
a second filter device is coupled between the respective timing relay and the respective turn-off input in each case.

8. The circuit arrangement as claimed in claim 4,
wherein
a respective diode is coupled between the respective inductor and the respective thyristor simulation.

9. The circuit arrangement as claimed in claim 4,
wherein
the respective thyristor simulation comprises a PNP transistor and an NPN transistor in each case, wherein the working electrode of the PNP transistor is coupled to the turn-off input and the control electrode of the NPN transistor is coupled to the turn-on input of the respective thyristor simulation.

10. The circuit arrangement as claimed in claim 1,
wherein
the first and the second electronic switch are embodied as MOSFETs.

11. The circuit arrangement as claimed in claim 1,
wherein
a trapezoidal capacitor is coupled in parallel with at least one of the two electronic switches.

12. The circuit arrangement as claimed in claim 1,
wherein
it also includes a start circuit which is coupled between the first input terminal and the control electrode of the second electronic switch.

13. The circuit arrangement as claimed in claim 1,
wherein
it includes a storage capacitor which is coupled between the first and the second input terminal, the storage capacitor, in conjunction with the load circuit connected in parallel therewith, being configured in such a way that the supply voltage includes an alternating component of up to 50% referred to its peak value.

14. The circuit arrangement as claimed in claim 1,
wherein
a rectifier is coupled between the first inductor and the output of the circuit arrangement.

15. The circuit arrangement as claimed in claim 1,
wherein
a first winding of a transformer is coupled in series with the first inductor, wherein the transformer includes a second winding, a rectifier and the output of the circuit arrangement being coupled to the second winding.

16. The circuit arrangement as claimed in claim 1,
wherein
it additionally includes a fourth inductor and a rectifier, wherein the fourth inductor is magnetically coupled to the first, the second and the third inductor, wherein the rectifier is coupled between the fourth inductor and the output of the circuit arrangement.
